(19) United States
(12) Patent Application Publication
(10) Pub. No.: US 2008/0132409 A1
(43) Pub. Date: Jun. 5, 2008

(54) Fibrous Catalyst

(75) Inventors: Junji Ito, Yokohama-shi (JP); Masahiro Takaya, Yokosuka-shi (JP); Toshiharu Miyamura, Yokohama-shi (JP); Takeshi Yamauchi, Yokosuka-shi (JP)

Correspondence Address: YOUNG & BASILE, P.C., 3001 WEST BIG BEAVER ROAD, SUITE 624, TROY, MI, 48084, US

(73) Assignee: NISSAN MOTOR CO., LTD., Yokohama-shi (JP)

(21) Appl. No.: 11/930,648

(22) Filed: Oct. 31, 2007

(30) Foreign Application Priority Data
Dec. 1, 2006 (JP) 2006-325121
Jul. 30, 2007 (JP) 2007-197764

(51) Int. Cl. B01J 23/10; B05D 3/02

(52) U.S. Cl. 502/304; 427/372.2

(57) ABSTRACT

Herein is provided a fibrous catalyst having a catalytic layer containing particles comprising ceria CeO₂, with an average particle size of 1 nm to 1 μm. The layer is coated on the surface of a ceramic fiber. Accordingly, flexibility of the surface of the catalytic layer is improved due to the decreased interaction between the particles due to their minute size. Because flexibility is improved, vibration and deformation does not deteriorate the layer, and as such, the peeling-resistance property is improved.

### CROSS-REFERENCE TO RELATED APPLICATIONS

This application claims priority from Japanese Patent Application Serial Nos. 2006-325121, filed Dec. 1, 2006, and 2007-197764, filed Jul. 30, 2007, each of which is incorporated herein in its entirety by reference.

### TECHNICAL FIELD

The invention relates in general to a fibrous catalyst wherein a catalyst is carried on a surface of a fibrous ceramic.

### BACKGROUND

In recent years, the number of automobiles has increased remarkably, and proportionally the amount of exhaust gas discharged from the internal combustion engines of the automobile has increased. Because various materials contained in the exhaust gas of diesel engines cause pollution, the global environment is being affected. Moreover, in recent years, there are reported findings that particulates such as soot contained in the exhaust gas cause allergies and asthma as well as impairing sperm count in men. Measures to remove the particulates in the exhaust gas are desirable.

Conventionally, purifying filters are used to remove particulates such as hydrocarbon (XC), carbon monoxide (CO) and nitrogen oxide (NOx). A catalytic coat layer is formed on a surface of a catalyst carrier made of ceramic fibrous material, and this catalytic coat layer carries the catalyst made of noble metals such as Pt, Pd and Rh and alkali metal, and so on. The catalytic carrier is impregnated by a slurry including alumina powder and then dried and fired to form the catalytic coat layer on the surface of the catalyst carrier. By this purifying filter, when the exhaust gas passes though the purifying filter, it is possible to effectively perform oxidation removal of the carbon monoxide and the hydrocarbon, and also reduce the nitrogen oxide.

To improve the carrying strength of such a catalyst carrier, in general, a method is known to impregnate a silica gel and then heat the carrier and silica gel by a predetermined temperature. By applying this method, the water content in the silica sol is evaporated by the heating to form porous gel, including particulates of the silica. Accordingly, it is possible to strengthen the catalyst by this filling effect. This method is described in Japanese Patent Application Publication No. 55-155740.

### BRIEF SUMMARY

Taught herein are embodiments of an inventive fibrous catalyst. One such catalyst includes, by example, a ceramic fiber carrier and a catalyst layer coated on the ceramic fiber carrier, the catalyst layer including ceria-containing particles having an average particle size of between 1 nm and 1 μm.

Methods of preparing a preparing a fibrous catalyst capable of withstanding mechanical stresses are also taught herein. One method comprises mixing a sol of ceria and active catalyst material, spraying the sol on a ceramic fiber carrier until an entire surface of the ceramic fiber carrier has an even coat, drying the coated ceramic fiber carrier and firing the ceramic fiber carrier.

### BRIEF DESCRIPTION OF DRAWINGS

The description herein makes reference to the accompanying drawings wherein like reference numerals refer to like parts throughout the several views, and wherein:

FIG. 1 is an electron micrograph showing an appearance of a fibrous catalyst obtained by Example 1;

FIG. 2 is an electron micrograph showing an appearance of a fibrous catalyst obtained by Example 2;

FIG. 3 is an electron micrograph showing an appearance of a fibrous catalyst obtained by Example 3;

FIG. 4 is a photograph showing a bending test method used in the Examples;

FIG. 5 is an electron micrograph showing an appearance of the fibrous catalyst obtained by Example 1 after the bending test;

FIG. 6 is an electron micrograph showing an appearance of the fibrous catalyst obtained by Example 2 after the bending test;

FIG. 7 is an electron micrograph showing an appearance of the fibrous catalyst obtained by Example 3 after the bending test;

FIG. 8 is a transmission electron micrograph showing a section of texture of the fibrous catalyst obtained by Example 2;

FIG. 9 is a transmission electron micrograph showing a section of texture of the fibrous catalyst obtained by Comparative Example 2;

FIG. 10 is an illustrative view showing an observation direction in FIGS. 8 and 9;

FIG. 11 is an illustrative diagrammatic view showing a measuring method of particulate matter collection;

FIG. 12 is an illustrative view showing a relationship between a particulate matter collection amount with presence and absence of the catalytic layer; and

FIG. 13 is a graph showing a relationship between a catalyst temperature and a particulate matter removal ratio in the fibrous catalyst of Example 3.

### DETAILED DESCRIPTION OF EMBODIMENTS OF THE INVENTION

Herein is proposed an exhaust gas purifying filter provided with a catalyst carrier made of a ceramic fiber material used for purifying the exhaust gas of a diesel engine, for example. This exhaust gas purifying filter is received in a casing provided in an exhaust pipe through which the exhaust gas is discharged from the internal combustion engine. The exhaust gas discharged from the internal combustion engine passes through the purifying filter, and the particulates contained in that exhaust gas are removed.

Conventional methods are effective for catalyst carriers that are not exposed to mechanical stresses. Even where a ceramic fiber material is used as a catalyst carrier, the carrier cannot be impregnated using a slurry due to its smooth surface. Because of surface tension, the catalyst layer is unevenly distributed across the ceramic fibrous material. This uneven coat decreases the catalytic activity.

In contrast to conventional methods, a fibrous catalyst carrier is provided herein in which the catalytic coat layer strongly adheres to the ceramic fiber material of the carrier, preventing the catalyst components from peeling off of the fibrous carrier and improving coating consistency. It has been discovered that this goal can be attained using ceria-containing particles contained in the catalyst coat layer, those particles having a nano level particle size. The ceria-containing particles contained in the catalytic layer coated on the surface of the ceramic fiber have average particle sizes in the range of 1 nm to 1 μm. Accordingly, it is possible to increase adhesive force of the catalytic layer to the surface of the ceramic fiber catalyst carrier, to prevent the catalytic components from peeling off from the carrier, and to improve durable life of the fibrous catalyst.

Hereinafter, fibrous catalysts according to the invention are illustrated more in detail. In this description, a percentage represents percent by mass if not otherwise specified.

In the fibrous catalysts embodied herein, a catalytic layer containing particles comprising ceria, such as CeO₂, having an average particle size of 1 nm to 1 μm is coated on the surface of the ceramic fiber. Accordingly, flexibility of the surface of the catalytic layer is improved due to the decreased interaction between the particles due to their minute size. Because flexibility is improved, vibration and deformation does not deteriorate the layer, and as such, the peeling-resistance property is improved.

In the fibrous catalyst disclosed herein, the ceramic fiber serving as the catalyst carrier is not limited to particular fibers. For example, fibers including one or more of alumina (Al₂O₃), zirconia (ZrO₂), titania (TiO₂), or silica (SiO₂) may be used. These materials have a specific surface area and accordingly are optimal as ceramic fibers for carrying catalyst components because the radius of the ceramic fibers is more important than the thinness as far as optimizing the physical surface area. These ceramic fiber materials may be used as filaments or configured in the aggregate, such as in woven or non-woven fabrics, felt and paper made of the ceramic fiber.

In the fibrous catalyst described herein, a sol comprising the ceria-containing particles has an average particle size of 1 nm to 1 μm. By using the minute sol as the catalyst component, the mechanical strength is increased, the coat layer is thinner, and the filling density of the fiber is improved. In certain embodiments, the thickness (size) of the ceramic fiber is about 1 to 50 μm.

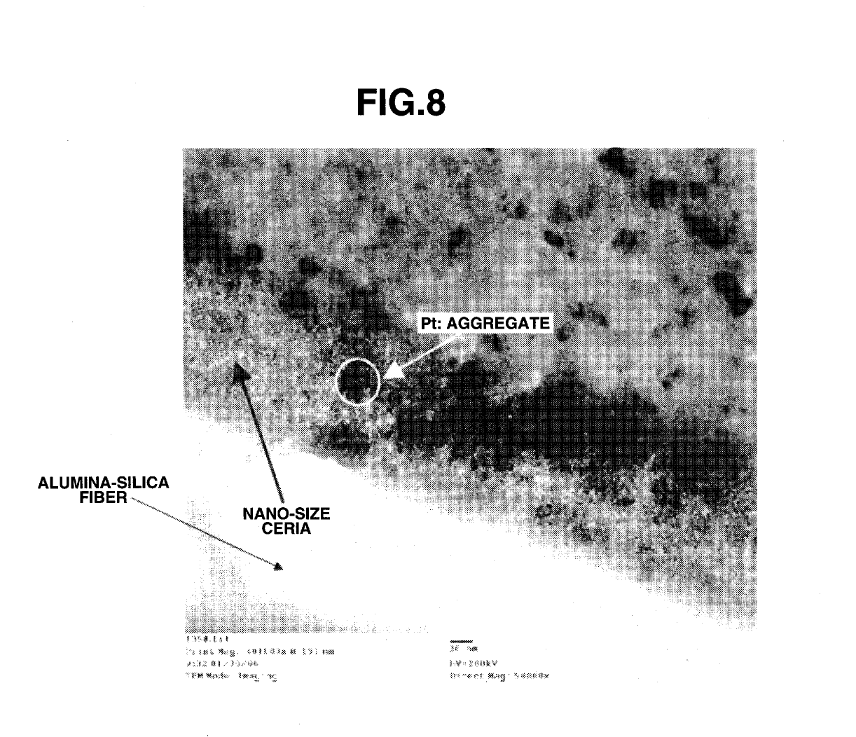

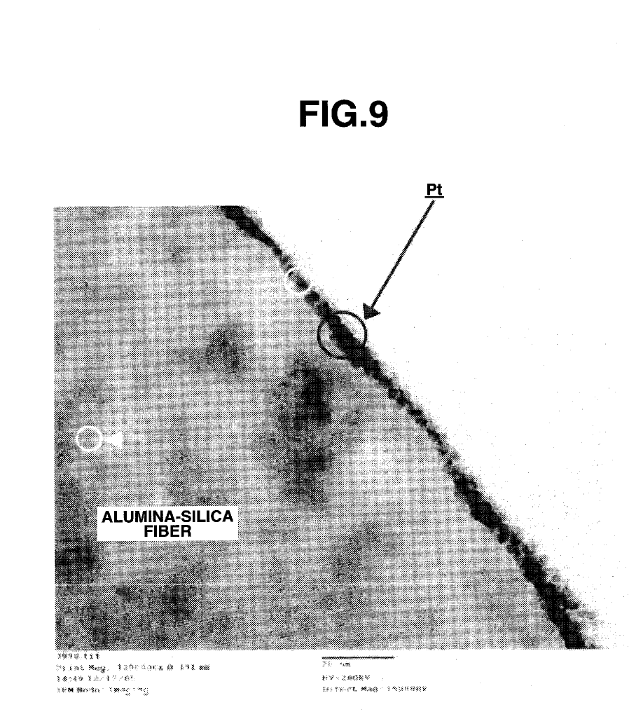

The active catalyst material used in the fibrous catalyst embodiments disclosed may be, for example, metals that include noble metals, transition metals and rare earth metals. In certain embodiments, optimum coating adhesion results when the ceria particles are intervened between the platinum particles while abutted directly to the ceramic fiber. The positioning of the ceria particles on the ceramic fibers and between the fibers and the active catalyst material provides excellent adhesion of the catalyst coat layer, impeding the peeling of the coat due to mechanical stresses. According, in embodiments where the distance between individual active catalyst particles is wider than the ceria-containing particle size, particularly desirable adhesion properties result. This distribution can be seen in FIGS. 8 and 9.

In certain embodiments, the ceria-containing particles are a ceria-praseodymium or a ceria-manganese. It has been found that a sol not including CeO₂ tends to decrease in surface area after being coated on the carrier and fired, whereas the use with CeO₂ highly disperses the praseodymium and the manganese. That is, the ceria particles act as a toughening agent. Moreover, the ceria is also beneficial as an active oxygen discharging agent and as a promoter. Accordingly, the catalyst capability is remarkably improved by the use of ceria.

The fibrous catalyst disclosed herein is applicable to, for example, purifying an exhaust gas discharged from an internal combustion engine of automobile. In view of this use, it is desirable that the catalyst layer is sufficiently adhered to the ceramic fiber carrier so that active catalyst is not lost due to peeling-off of the layer from the fibrous material. It is further desirable that the ceramic fiber itself is not broken even in the case of bending to a radius of curvature of 10 mm and an angle of 90°.

Hereinafter, the invention is illustrated more in detail based on examples. However, the invention is not limited only to these examples.

A first example utilizes a ceria-containing particle with ceria sol concentration of 15 percent by mass and an average particle size of 5 nm. This solution was inserted into a sprayer and sprayed on an alumina-silica fiber having an average fiber length of 3 mm and an average fiber radius of 15 μm until the entire surface is evenly colored. Such a finer is manufactured by, for example, Nitivy Co. Ltd. The fibrous catalyst of Example 1 was dried at 120° C. for 1 hour and fired at 400° C. for 1 hour. Consequently, a catalyst layer having a thickness of 1 μm was formed on the surface of the fiber.

The same process as described above was repeated for manufacturing a second example with an alternate ceria-containing particle. The ceria-containing particle used in the second embodiment is a solution of dinitrodiammine platinum, the concentration of the solution being 0.3 percent by mass. After drying the fibrous catalyst at 120° C. for 1 hour and firing at 400° C. for 1 hour, the fibrous catalyst of Example 2 was obtained with a thickness of the catalyst layer of 1 μm.

The same process as described above was repeated for manufacturing a third example with an alternate ceria-containing particle. The ceria-containing particle used in the third example is a solution of Ce—Pr—Ox sol having an average particle size of 60 nm. After drying the fibrous catalyst at 120° C. for 1 hour and firing at 400° C. for 1 hour, the fibrous catalyst of Example 3 was obtained with a thickness of the catalyst layer of 1 μm.

As a first comparative example, CeO₂ of 200 g and a Boehmite sol of 50 g was mixed, added with a solution of nitric acid 10%, and pulverized by a ball mill, thus making a slurry. An average particle size in this case was 3.5 μm. The above-described alumina-silica fiber was impregnated in this slurry, and excessive coat amount is extruded by suction, dried at 120° C. for 1 hour and fired at 400° C. for 1 hour. Consequently, the fibrous catalyst of comparative example 1 was obtained.

For a second comparative example, the same process was used as was used for the first comparative example except that the ceria sol was not used. The fibrous catalyst of comparative example 2 was obtained.

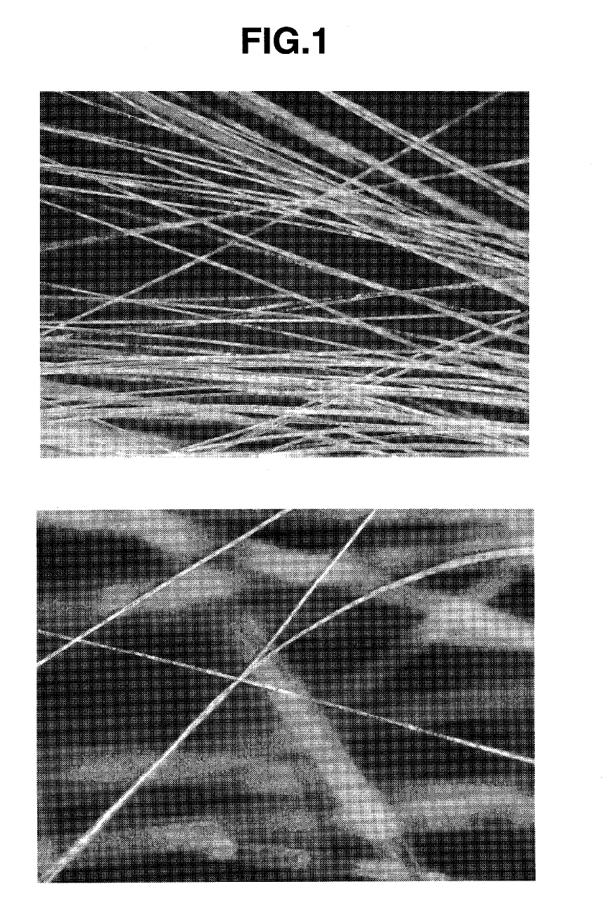

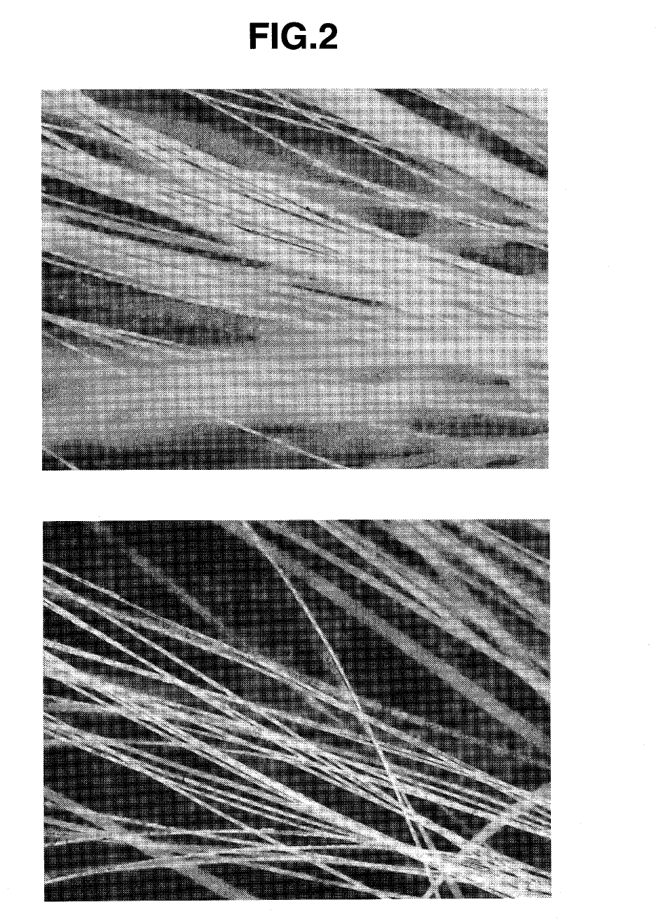

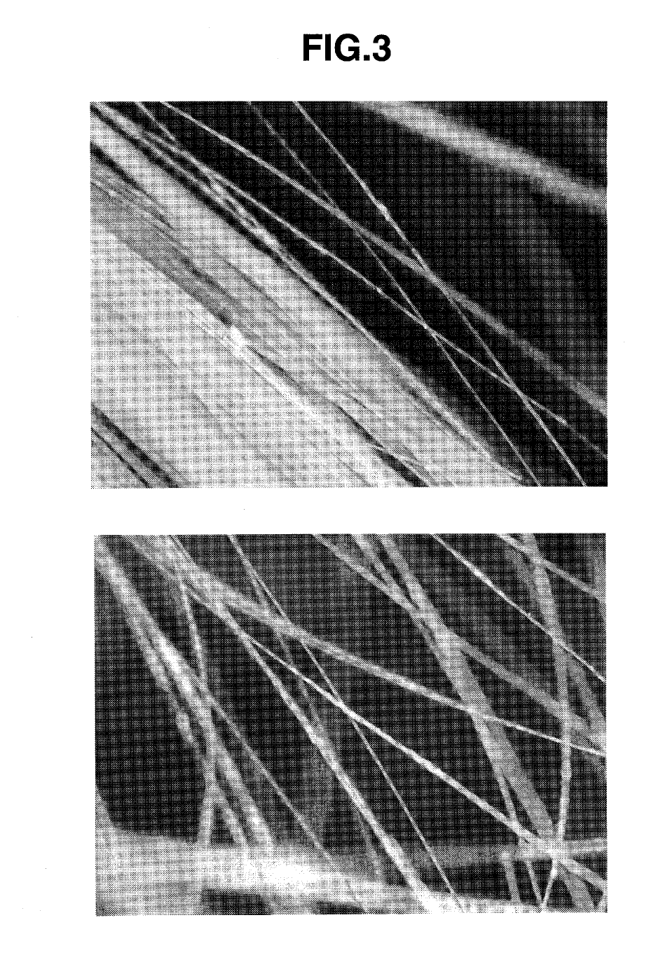

Appearances of the fibrous catalysts obtained by the above-described Examples 1 and 2 and Comparative Example 1 were investigated by electron micrograph. The appearances of the fibrous catalysts are shown, respectively, in FIGS. 1, 2 and 3. The electron micrograph revealed that in the fibrous catalyst (Comparative Example 1) using the slurry containing the ceria the particles adhered to the fiber carrier in a lump. The fibrous catalysts according to Examples 1 and 2 using the ceria sol having an average particle size of 5 nm were revealed by the micrograph to have no lumps, but rather a consistent coat.

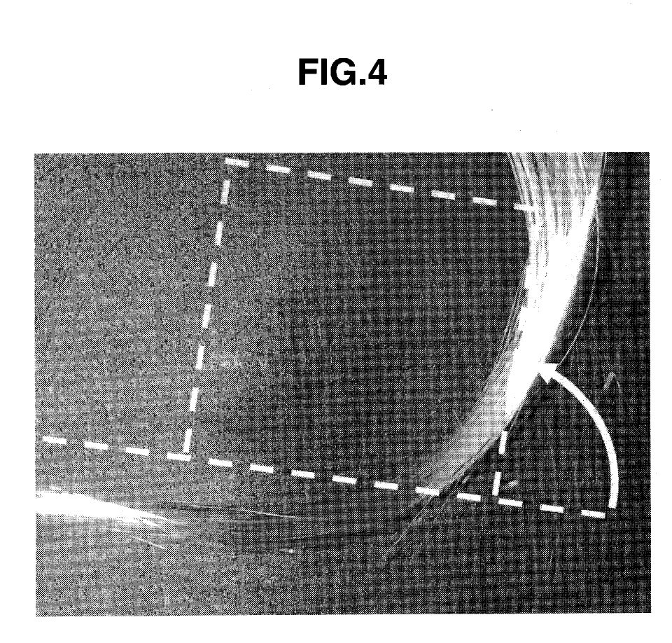

A bending test at a radius of curvature of 10 mm and an angle of 90° was performed on the respective fibrous catalysts obtained by Examples 1 and 2 and Comparative example 1 as shown in FIG. 4. Visual observation of the state of the catalyst layers was made after the bend test. These results are shown in Table 1.

TABLE 1

| | | | Catalyst layer |
|---|---|---|---|
| Example | Ceramic fiber | Coat solution | after bending test |
| Example 1 | Alumina-silica | Ceria-sol (5 nm size) | Dropping absent |
| Example 2 | Length: | Ceria-sol (5 nm | Dropping absent |
| | 3.0 mm | size) + Pt | |
| Example 3 | Raidus: 15 μm | Ce—Pr-Ox sol | Dropping absent |
| | | (60 nm size) | |
| Comparative | | Ceria powder | Dropping present |
| Example 1 | | (3.5 μm size) | |
| Comparative | | Pt | Dropping present |
| Example 2 | | | |

The results show that in the fibrous catalysts in Examples 1 and 2 using the ceria sol having an average particle radius of 5 nm and in Example 3 using Ce—Pr—Ox sol having an average particle radius of 60 nm, the catalyst layer did not peel off of the fibrous carrier during the bending test, indicating high mechanical strength. On the other hand, Comparative Example 1 using the slurry containing the ceria of an average particle size of 3.5 μm and Comparative Example 2 without the ceria both showed peeling-off of the catalyst layer from the fibrous carrier.

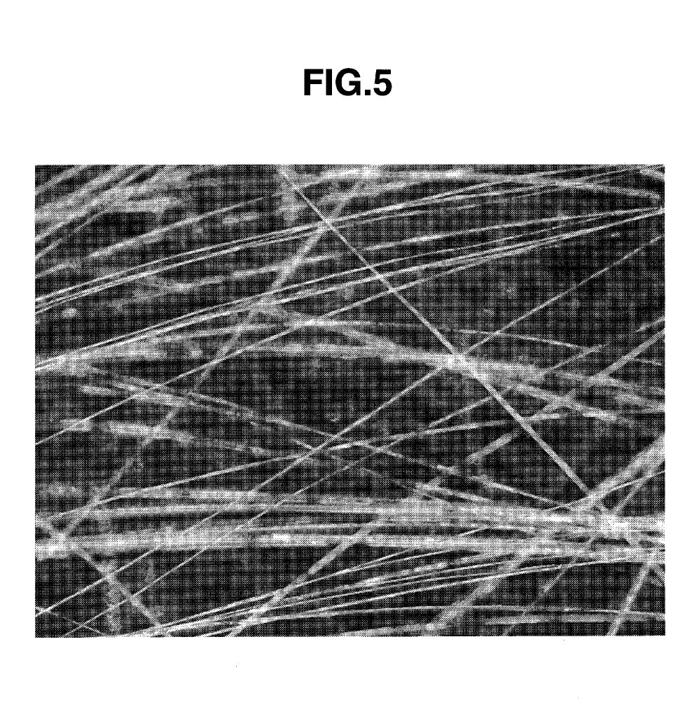

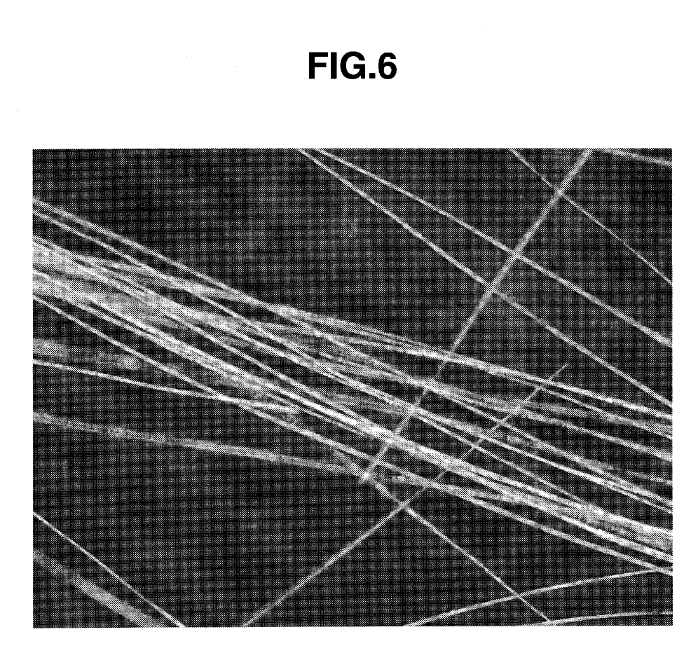

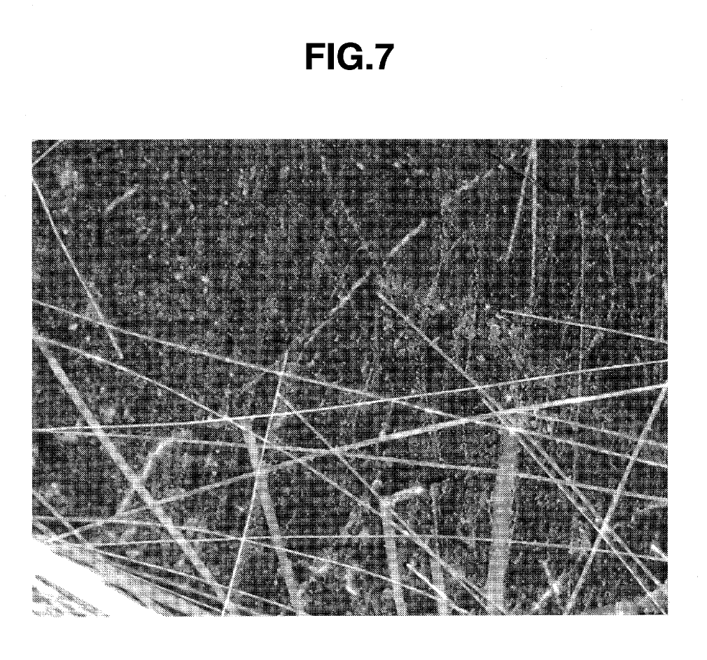

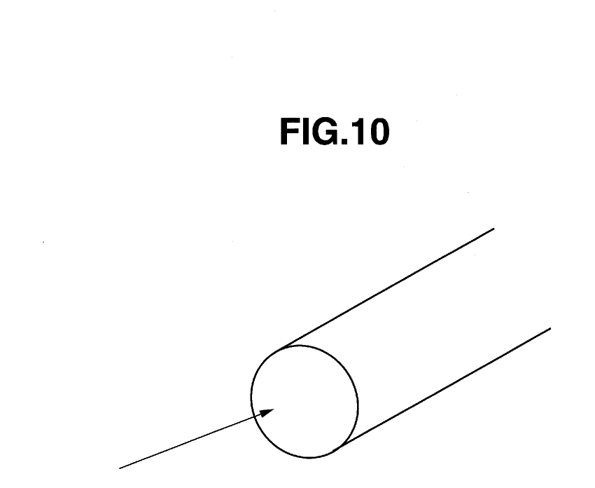

The appearances of the fibrous catalysts after the bending test are shown, respectively, in FIG. 5 (Example 1), FIG. 6 (Example 2) and FIG. 7 (Comparative Example 1). Moreover, as to the fibrous catalysts obtained by the above-described Example 2 and Comparative Example 2, observation results of the cross section of texture by transmission electron microscope from the direction shown in FIG. 10 are shown, respectively, in FIGS. 8 and 9.

In the fibrous catalyst according to Example 2, the nano-size ceria intervenes in the spaces of the ceramic fibers, as shown in FIG. 8. Accordingly, contact interface with the fiber increases, and hydrogen bonds generated between OH of the surface of the fiber and OH of the surface of the ceria increase. Consequently, dropping or peeling of the catalyst layer is prevented. In the fibrous catalyst obtained in Comparative Example 2, the contact interface between the Pt particles and the fibers is increased as shown in FIG. 9. There is little hydrogen bonding with the OH of the surface of the fiber because Pt is metal. Consequently, peeling and dropping of the catalyst layer was not fully prevented.

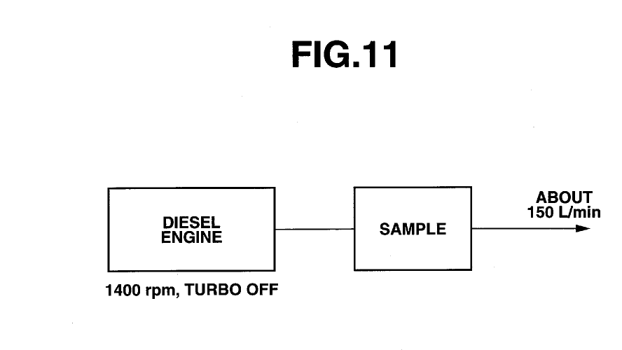

The fibrous catalyst obtained in Example 3 was evaluated by a particulate matter burning test as shown in FIG. 11. The exhaust gas flowed from a diesel engine as shown in FIG. 11. The gas flowed from the start of the supply for 90 minutes.

In the measure of the particulate matter (PM) collection amount, the sample was detached and left in the air at 25° C. and a humidity of 60% for 8 hours and more. A first measurement of weight is performed, and then the sample was fired in a muffle furnace at 800° C. for 1 hour to remove PM. It was left in the air at 25° C. and a humidity of 60% for 8 hours and more, and then a second measurement of weight was performed. The difference between the first measured weight and the second measured weight represents the amount of PM collected. Error of the weight by this measurement is 0.003 g.

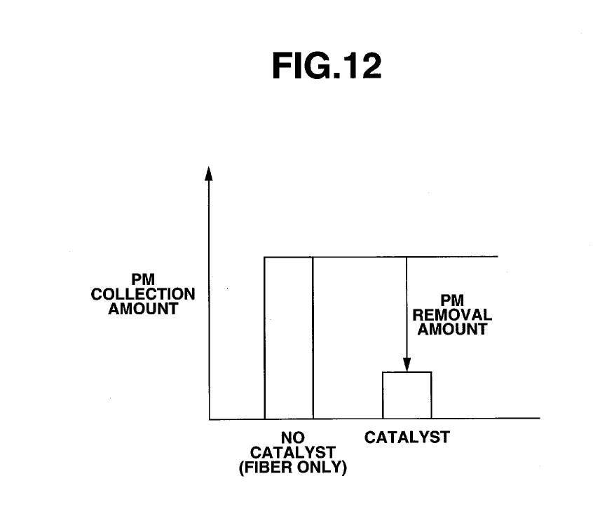

The PM collection amounts obtained by the above-described method were compared in the case of a fiber only with no catalytic layer and in the case of the fibrous catalyst of Example 3 having a catalytic layer formed on the fiber. This difference is represented by a PM removal amount as shown in FIG. 12. The difference is the effect of the catalytic layer. The PM removal rate is calculated as follows:

PM removal rate PM removal amount/PM collection amount*100.

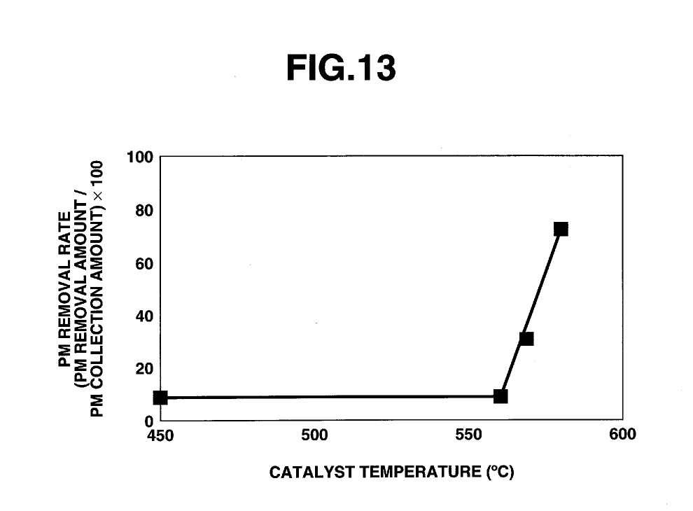

Temperatures of the catalyst were changed to four levels of 450° C., 560° C., 570° C. and 580° C., and the above-described measurements were performed. These results are shown in Table 2 and FIG. 13.

TABLE 2

| | PM | PM collection | | PM removal |
|---|---|---|---|---|
| | collection | amount by | PM removal | rate |
| Catalyst | amount by | catalyst of | amount | 100(Wf − Wc)/ |
| temperature | fiber only | Example 3 | Wf − Wc | Wf |
| (° C.) | Wf (g) | Wc (g) | (g) | (%) |
| 450 | 0.033 | 0.030 | 0.003 | 9 |
| 560 | 0.024 | 0.022 | 0.002 | 8 |
| 570 | 0.013 | 0.008 | 0.005 | 38.4 |
| 580 | 0.013 | 0.003 | 0.010 | 76.9 |

As these results from the fibrous catalyst obtained in Example 3 show, considering an error range of ±0.003 g, it is not predicated that there is effect. However, the results confirm that large PM removal rates are obtained, largely exceeding the range of the experimental error, between 570° C. and 580° C. as shown in FIG. 13.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A fibrous catalyst comprising:
a ceramic fiber carrier; and
a catalyst layer coated on the ceramic fiber carrier, the catalyst layer including ceria-containing particles having an average particle size of between 1 nm and 1 μm.

2. The fibrous catalyst according to claim 1 wherein the catalyst layer further comprises an active catalyst material.

3. The fibrous catalyst according to claim 2 wherein the ceria-containing particles contact the ceramic fiber carrier and are disposed between the ceramic fiber carrier and the active catalyst material, and are disposed between individual particles of the active catalyst material.

4. The fibrous catalyst according to claim 3 wherein the active catalyst material comprises at least one of a noble metal, a transition metal and a rare earth metal.

5. The fibrous catalyst according to claim 2 wherein the ceria-containing particles comprise an inorganic oxide.

6. The fibrous catalyst according to claim 2 wherein the ceria-containing particles comprise cerium oxide.

7. The fibrous catalyst according to claim 2 wherein the catalyst layer has an adhesive strength resisting bending to at least a radius of curvature of 10 mm and at least a bending angle of 90°.

8. The fibrous catalyst according to claim 1 wherein the catalyst layer has an adhesive strength resisting bending to at least a radius of curvature of 10 mm and at least a bending angle of 90°.

9. The fibrous catalyst according to claim 8 wherein the ceria-containing particles comprise an inorganic oxide.

10. The fibrous catalyst according to claim 8 wherein the ceria-containing particles comprise cerium oxide.

11. The fibrous catalyst according to claim 8 wherein the ceria-containing particles comprise at least one of a ceria-praseodymium and a ceria-manganese.

12. The fibrous catalyst according to claim 1 wherein the ceria-containing particles comprise an inorganic oxide.

13. The fibrous catalyst according to claim 1 wherein the ceria-containing particles comprise cerium oxide.

14. The fibrous catalyst according to claim 1 wherein the catalyst layer has an adhesive strength resisting bending to at least a radius of curvature of 10 mm and at least a bending angle of 90°.

14. The fibrous catalyst according to claim 14 wherein the ceria-containing particles comprise cerium oxide.

16. The fibrous catalyst according to claim 14 wherein the ceria-containing particles comprise at least one of a ceria-praseodymium and a ceria-manganese.

17. The fibrous catalyst according to claim 1 wherein the ceramic fiber carrier comprises an aggregation of fibers.

18. The fibrous catalyst according to claim 1 wherein the fibrous catalyst is an exhaust gas purifying catalyst for purifying an exhaust gas discharged from an internal combustion engine.

19. A method of preparing a fibrous catalyst to withstand mechanical stresses, the method comprising:
mixing a sol of ceria and active catalyst material;
spraying the sol on a ceramic fiber carrier until an entire surface of the ceramic fiber carrier has an even coat;
drying the coated ceramic fiber carrier; and
firing the ceramic fiber carrier.

20. The method according to claim 19 wherein the coat has a thickness of 1 μm.
